(19) United States
(12) Patent Application Publication
(10) Pub. No.: US 2026/0192871 A1
(43) Pub. Date: Jul. 9, 2026

(54) MODULAR ROOFING CART

(71) Applicant: LEADING EDGE SAFETY, LLC, Kansas City, MO (US)

(72) Inventors: Brent Edward Smith, Kansas City, MO (US); Wyatt Smith, Kansas City, MO (US); Travis Michael Budenbender, Shawnee, KS (US)

(21) Appl. No.: 19/010,653

(22) Filed: Jan. 6, 2025

(51) Int. Cl. B62D 49/06; B60K 1/00; B60L 50/60; B60P 1/04; B62D 51/00; B62D 51/02; B62D 51/04; B66F 9/075; E04D 15/06

(52) U.S. Cl. CPC B62D 49/065; B60K 1/00; B60L 50/60; B62D 51/005; B62D 51/02; B62D 51/04; B66F 9/07513; B66F 9/0759; E04D 15/06; B60P 1/04

(57) ABSTRACT

A roofing cart for use on a roof and compatible with a number of roofing implements. The roofing cart broadly comprises a chassis and a number of wheels. The chassis includes a coupler. The wheels are rotatably connected to the chassis for traversing the roof. The coupler is configured to interchangeably connect to the roofing implements.

### BACKGROUND OF THE INVENTION

Roofing projects often require multiple types of equipment to transport materials, clean surfaces, and perform other specific tasks. This results in significant costs and operational inefficiency.

### SUMMARY OF THE INVENTION

In one embodiment of the present invention, there is provided a roofing cart for use on a roof and compatible with a number of roofing implements. The roofing cart broadly comprises a chassis and a number of wheels. The chassis includes a coupler. The wheels are rotatably connected to the chassis for traversing the roof. The coupler is configured to interchangeably connect to the roofing implements.

In another embodiment of the present invention, there is provided a roofing cart for use on a roof. The roofing cart broadly comprises a chassis, a number of wheels, a dump bucket, a forklift, and a roll handler. The chassis includes a coupler. The wheels are rotatably connected to the chassis for traversing the roof. The dump bucket is configured to receive roofing material. The forklift is configured to support roofing material. The roll handler is configured to hold a roll of roofing material. The coupler is configured to interchangeably connect to the dump bucket, the forklift, and the roll handler.

In yet another embodiment of the present invention, there is provided a roofing cart for use on a roof. The roofing cart broadly comprises a chassis, a number of wheels, a variable speed electric motor, a replaceable battery, a dumb bucket, a forklift, a roll handler, a platform, a seat, and a monitoring and control system. The chassis includes a coupler and a hitch on opposite ends thereof. The wheels are rotatably connected to the chassis for traversing the roof. The variable speed electric motor is configured to drive one of the wheels. The replaceable battery is configured to provide power to the electric motor. The dump bucket is configured to receive roofing material. The forklift is configured to support roofing material. The roll handler is configured to hold a roll of roofing material. The platform is supported on the chassis for standing thereon. The seat is supported on the chassis for sitting thereon such that the roofing cart is configured to operate in a walk-behind mode, a stand-on mode, and a sit-on mode. The monitoring and control system is configured to transmit a wireless signal representing data pertaining to the roofing cart and receive a wireless signal representing a command for remotely controlling the roofing cart. The coupler is configured to interchangeably connect to the dump bucket, the forklift, and the roll handler. The hitch is configured to interchangeably connect to a number of roofing implements.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE FIGURES

Embodiments of the present invention are described herein with reference to the following drawing figures, wherein:

FIG. 1 is a perspective view of a roofing cart constructed in accordance with an embodiment of the invention;

FIG. 2 is a perspective view of the roofing cart of FIG. 1;

FIG. 3 is a bottom perspective view of the roofing cart of FIG. 1;

FIG. 4 is a bottom perspective view of the roofing cart of FIG. 1;

FIG. 5 is a perspective view of the roofing cart of FIG. 1;

FIG. 6 is a perspective view of the roofing cart of FIG. 1;

FIG. 7 is a perspective view of a roofing cart constructed in accordance with another embodiment of the invention; and

FIG. 8 is a schematic diagram of certain components of the roofing cart of FIG. 1.

1The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the present invention references various embodiments. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

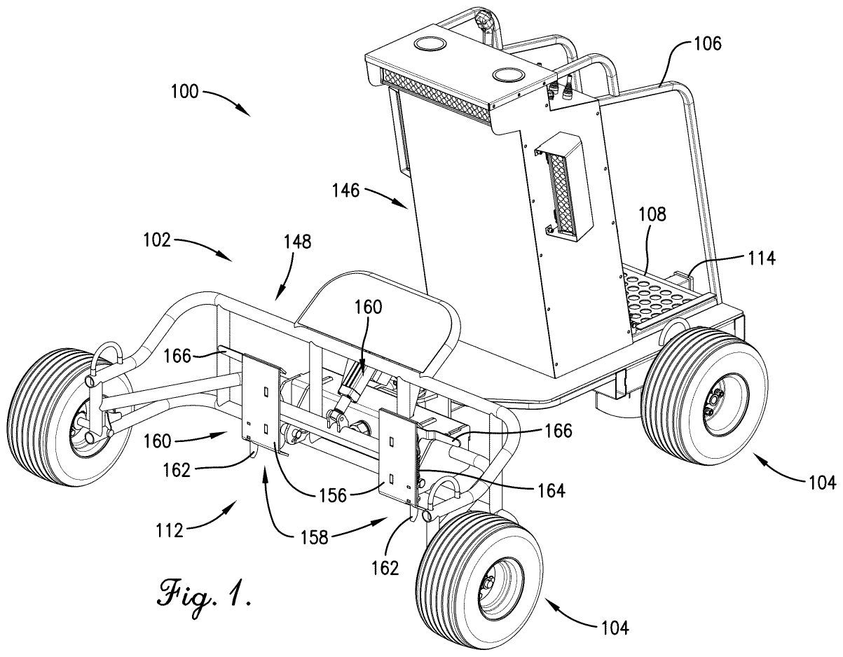

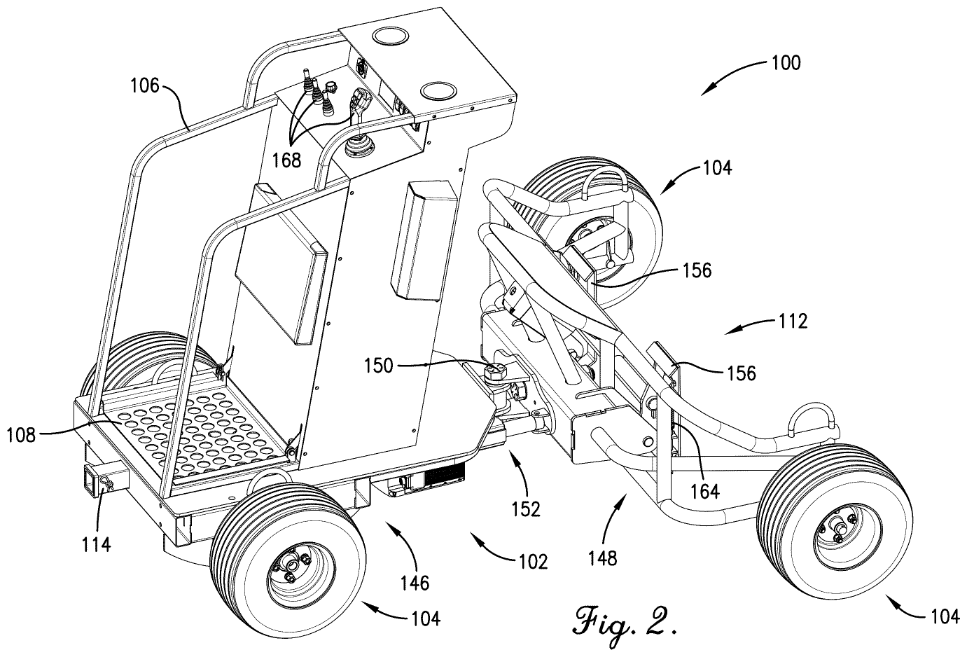

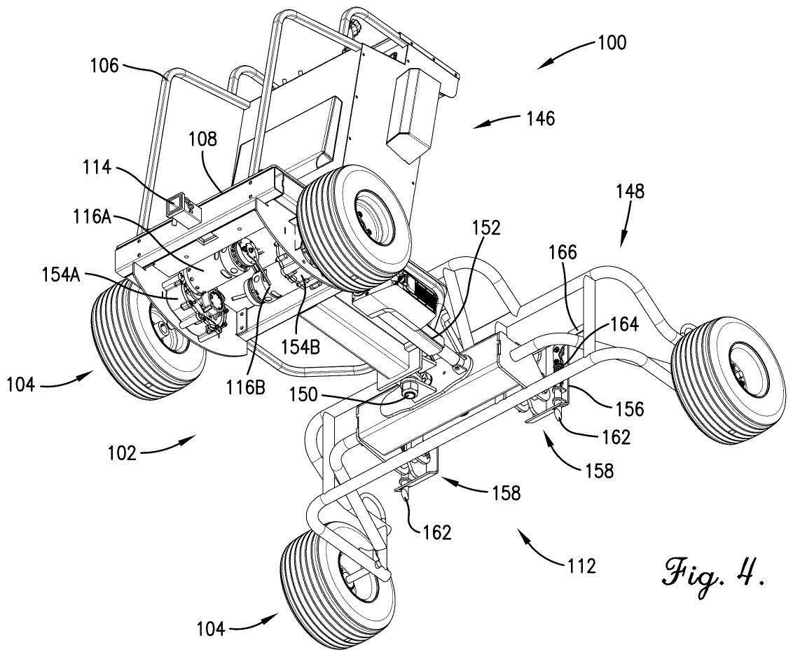

Embodiments of the present invention are directed generally to roofing carts. Turning to FIGS. 1-6 and 8, an embodiment of the invention is a roofing cart 100 broadly comprising a chassis 102, a plurality of wheels 104, a handle 106, a platform 108, a seat 110, a coupler 112, a hitch 114, left and right electric motors 116A,B, left and right transmissions 97A,B a battery 118, a regenerative braking system 120, a dust suppression system 122, a HEPA filtration system 124, and a monitoring and control system 126.

The chassis 102 supports the coupler 112, the electric motors 116A,B, the transmissions 97A,B, the battery 118, and components of the monitoring and control system 126. The chassis 102 may be a metal frame or similar structure and may include a rearward section 146, a forward section 148, a pivot point 150, and a steering link 152. The rearward section 146 may include or support the handle 106, the platform 108, the seat 110 and the hitch 114. The forward section 148 may be pivotably connected to the rearward section 146 via the pivot point 150 and may include or support the coupler 112. The steering link 152 may pivot the forward section 148 relative to the rearward section 146 and may be a hydraulic, pneumatic, or electric member.

The handle 106 may extend from the chassis 102 for allowing a user to push and/or steer the roofing cart 100. The platform 108 may be supported on the chassis 102 for allowing the user to stand on the roofing cart 100 during operation. The seat 110 may be supported on the chassis 102 for allowing the user to sit on the roofing cart 100 during operation. In this way, the roofing cart 100 may be operated in a walk-behind mode, a stand-on mode, and a sit-on mode.

The plurality of wheels 104 may be rotatably mounted on the chassis 102. At least some of the plurality of wheels 104 may be non-driven (i.e., “free-wheeling”). Some of the plurality of wheels 104 may be driven (i.e., “powered”) by the electric motors 116A,B via the transmissions 97A,B. At least one of the plurality of wheels 104 being driven helps reduce user fatigue, which improves safety. In one embodiment, the driven wheel may be configured to be selectively engaged and disengaged (i.e., changed between driven and non-driven).

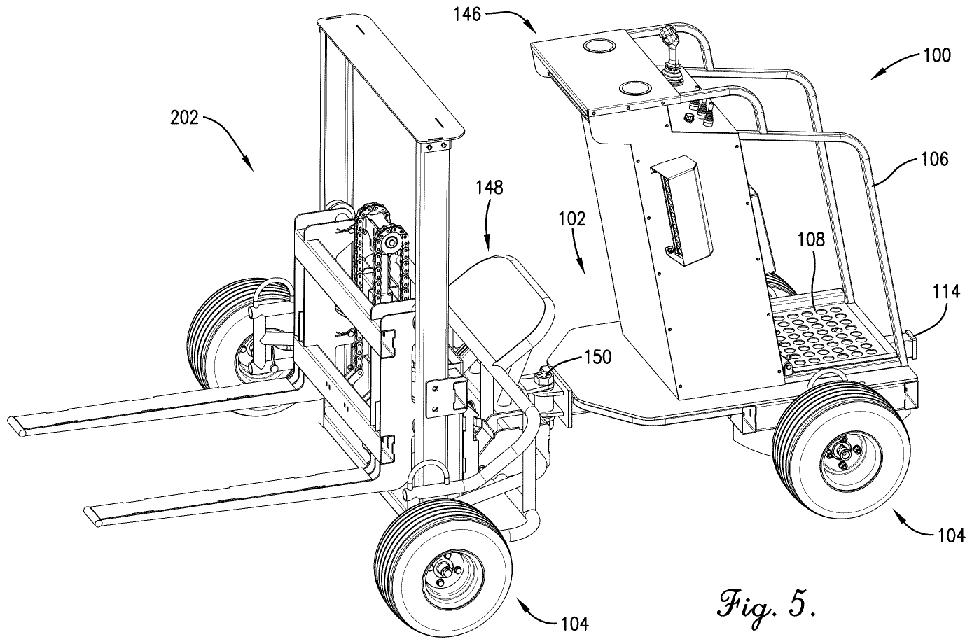

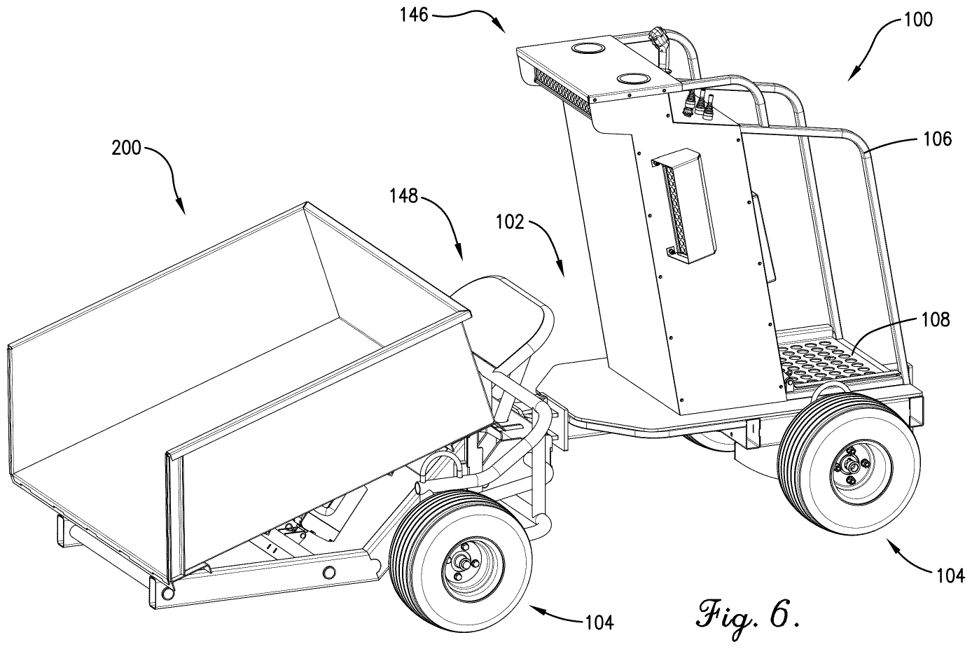

The coupler 112 may extend from a first end of the chassis 102 and may be configured to interchangeably connect to a plurality of roofing implements such as a dump bucket 200 (FIG. 6), a forklift 202 (FIG. 5), a roll handler, and other material handling implements, a sweeping implement, and the like. The coupler 112 may include supports 156, release mechanisms 158 and an engagement link 160. The supports 156 may be configured to contact corresponding structure of the dump bucket 200, forklift 202, roll handler 204, or other device. To that end, the supports 156 may be reinforced metal plates or similar structure. The release mechanisms 158 may each include a pin 162 configured to secure the coupled device to the coupler 112. The release mechanisms 158 may each further include a biasing element 164 (e.g., a spring) that biases the pin 162 into a secure position and a handle 166 for overcoming the spring bias and freeing the device from the coupler 112. The engagement link 160 may be a hydraulic, pneumatic, or electric member configured to shift the supports 156 into engagement with the device being coupled. For example, activation of the engagement link 160 may lift the coupled device off the roof surface so that the coupled device is fully supported on the roofing cart 100. Similarly, deactivation of the engagement link 160 may result in the supports 156 disengaging from the coupled device so that the coupled device is no longer supported by the roofing cart 100.

The hitch 114 may extend from a second end of the chassis 102 opposite the first end, and may be configured to interchangeably connect to a plurality of roofing implements such as a dump bucket 200, a forklift 202, a roll handler 204, a trailer, a sweeper, and the like so that the roofing cart 100 may tow the roofing implement connected via the hitch 114.

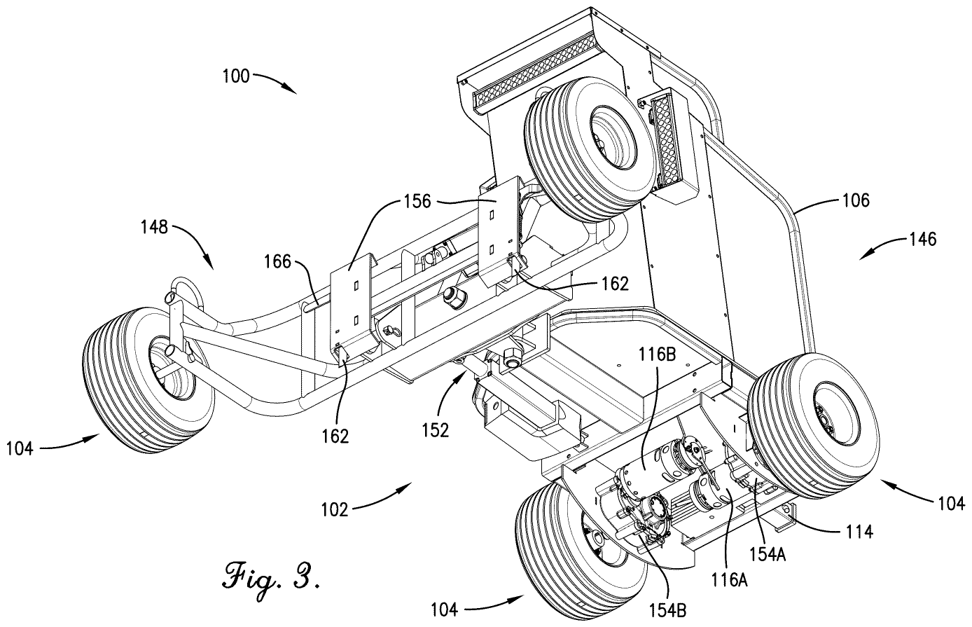

Turning to FIGS. 3, 4, and 8, the left and right electric motors 116A,B may be drivably connected to at least one of the plurality of wheels 104 via the transmissions 97A,B for propelling the roofing cart 100. The electric motors 116A,B may be a fixed speed, multi-speed, or variable speed motor. An electric motor for propelling the roofing cart 100 improves mobility thereof on rough, uneven, sloped, or otherwise difficult roofing surfaces.

The left and right transmissions 97A,B may drivably connect the left and right motors 116A,B to the driven wheels 104. The left and right transmissions 97A,B may be gearboxes and may be fixed gear, multi-gear, variable speed, or the like.

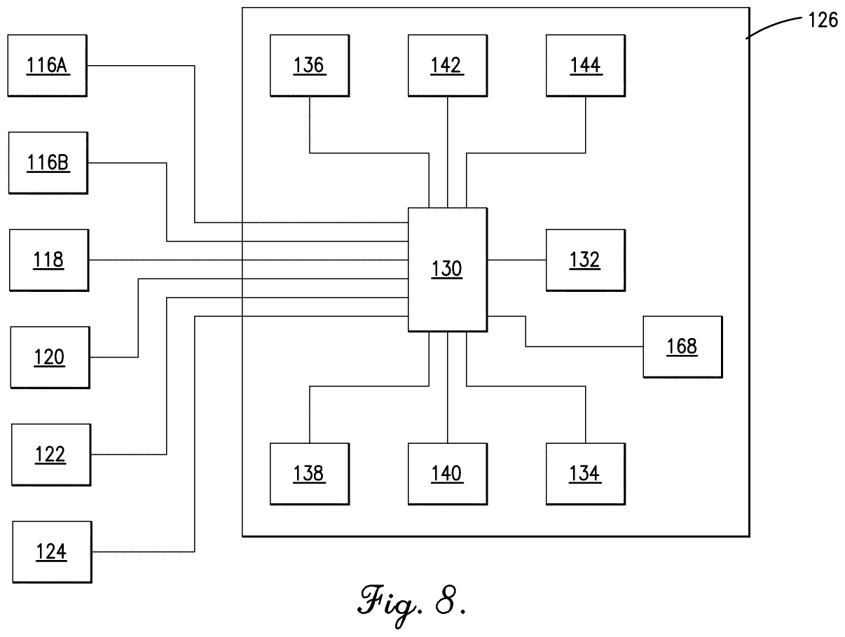

Turning to FIG. 8, the battery 118 may supply electrical power to the electric motors 116A,B. The battery 118 may be rechargeable, and permanent/fixed or removable/swappable. The battery 118 may be a lead acid battery, lithium battery, or any other suitable battery 118. The battery 118 may be one of a series of batteries. The battery 118 may be charged by an external charger upon removal of the battery 118 from the roofing cart 100, via an auxiliary power outlet 128, or via the regenerative braking system 120. Battery charging may be dictated by the monitoring and control system 126, as described in more detail below.

The auxiliary power outlet 128 may be connected to the battery 118 and may allow line power, a generator, a vehicle, or other roofing equipment to be electrically linked to the battery 118 and charge the battery as dictated by the monitoring and control system 126. The auxiliary power outlet 128 may also allow the roofing cart 100 to be operated directly via electrical power provided through the auxiliary power outlet 128. Furthermore, the auxiliary power outlet 128 may allow the battery 118 to charge other roofing equipment and other electrical or electronic devices, thus acting as an onsite power source. Power input and power output may be realized via separate auxiliary power outlets.

The regenerative braking system 120 may be integrated with the electric motors 116A,B. During braking or wind-down, the electric motors 116A, B may transmit electric energy to the battery 118, thus charging the battery 118.

The battery 118, auxiliary power outlet 128, regenerative braking system 120, and monitoring and control system 126 prevent low battery charge from causing a work stoppage or downtime and may ensure extended, continuous or near continuous operation. These features also reduce or eliminate the need for frequent recharging.

The dust suppression system 122 may dispense water or other liquid near or at the coupler 112 for suppressing dust stirred up by the coupler 112. The dust suppression system 122 reduces health risks of the user by minimizing inhalation of dust.

The HEPA filtration system 124 may utilize a vacuum directed near or at the coupler 112 to efficiently capture airborne particles stirred up by the coupler 112. This further reduces health risks and improves safety of roofing projects, improves project efficiency, and can be used in combination with or instead of the dust suppression system.

The monitoring and control system 126 may control the electric motors 116A, B, the steering link 152, the engagement link 160, charging of the battery 118, and the auxiliary power outlet 128, and may monitor data associated with the coupler 112. To that end, the monitoring and control system 126 may include a processor 130, a memory 132, a GPS unit 134, a first sensor 136, a second sensor 138, a transceiver 140, an operator switch 142, an emergency stop switch 144, and a plurality of control inputs 168.

The processor 130 may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processor 130 may generally execute, process, or run instructions, code, code segments, code statements, software, firmware, programs, applications, apps, processes, services, daemons, or the like. The processor 130 may also include hardware components such as registers, finite-state machines, sequential and combinational logic, configurable logic blocks, and other electronic circuits that can perform the functions necessary for the operation of the current invention. In certain embodiments, the processor 130 may include multiple computational components and functional blocks that are packaged separately but function as a single unit. The processor 130 may be in electronic communication with the other electronic components through serial or parallel links that include universal busses, address busses, data busses, control lines, and the like.

The memory 132 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. The memory 132 may include, or may constitute, a non-transitory “computer-readable medium”. The memory 132 may store the instructions, code, code statements, code segments, software, firmware, programs, applications, apps, services, daemons, or the like that are executed by the controller. The memory 132 may also store data that is received by the processor 130. The memory 132 may further store data or intermediate results generated during processing, calculations, and/or computations as well as data or final results after processing, calculations, and/or computations. In addition, the memory 132 may store settings, data, documents, sound files, photographs, movies, images, databases, and the like.

The GPS unit 134 may receive a signal or signals from GPS satellites and/or ground stations and may determine a position of the roofing cart 100. The GPS unit 134 may also determine a ground speed, an altitude, and other tracking-based information of the roofing cart 100 via the GPS signal(s).

The first sensor 136 may be configured to detect a surface type, a material type, a debris level, or the like. The first sensor 136 may be a proximity sensor, an optical sensor, or the like. The first sensor 136 may be configured to transmit a signal representing a surface type, material type, debris level, etc. to the monitoring and control system 126.

The second sensor 138 may be configured to detect obstacles, hazards, or the like. The second sensor 138 may be a proximity sensor, an optical sensor, or the like. The second sensor 138 may be configured to transmit a signal representing the obstacle or hazard to the monitoring and control system 126, which in turn may stop or change a speed of the electric motors 116A, B to avoid the obstacle or hazard.

The transceiver 140 may include signal and/or data transmitting and receiving circuits, such as antennas, amplifiers, filters, mixers, oscillators, digital signal processors (DSPs), and the like. The transceiver 140 may establish communication with other roofing equipment and with remote computing devices wirelessly by utilizing radio frequency (RF) signals and/or data that comply with communication standards such as cellular 2G, 3G, 4G, Voice over Internet Protocol (VoIP), LTE, Voice over LTE (VoLTE), or 5G, Institute of Electrical and Electronics Engineers (IEEE) 802.11 standard such as WiFi, IEEE 802.16 standard such as WiMAX, Bluetooth™, or combinations thereof.

The monitoring and control system 126 may implement a wired or wireless network that communicatively connects the roofing cart 100 with other roofing equipment and remote computing devices. The monitoring and control system 126 may also communicate with the other roofing equipment and remote computing devices via cellular radios, a radio frequency network, satellite radio, hard wiring, or any other suitable communication connection.

The monitoring and control system 126 may incorporate smart technology and/or “internet of things” (IoT) capabilities for enhanced operational efficiency including data collection and remote monitoring and control of the roofing cart 100. This may include wirelessly transmitting data pertaining to the roofing cart 100 to remote computing devices or other roofing equipment and wirelessly receiving commands for controlling the roofing cart 100 or inputs such as parameters, schedules, or other data that affects operation of the roofing cart 100. Such transmitted or received data may include data pertaining to users of the roofing cart 100 such as tag-in/tag-out information, task or job status, usage data, location of the roofing cart 100 (via GPS data), and the like. Data may be stored locally on the memory 132 or transmitted to remote computing devices or other roofing equipment. This data may also assist in investigating work incidents. The monitoring and control system 126 may also collect or transmit maintenance data and generate and transmit maintenance alerts and recommendations. The monitoring and control system 126 may include an integrated user interface or may utilize interfaces (such as a mobile application, program, or website) of mobile devices such as a user's cell phone, tablet, or laptop via its wireless connection.

The operator switch 142 may be configured to stop movement or operation of the roofing cart 100 upon an operator disengaging the operating switch 142. To that end, the operator switch 142 could be a foot switch or a switch activated by weight of the operator on the seat 110, for example. This provides a level of safety in case the operator becomes incapacitated or is not properly situated for operating the roofing cart 100.

The emergency stop switch 144 may be configured to stop movement or operation of the roofing cart 100 upon an operator engaging the emergency stop switch 144. To that end, the emergency stop switch 144 may be a large, prominent button or lever within easy reach of the operator. This provides a level of safety in case the operator needs to quickly stop movement or operation of the roofing cart 100.

The monitoring and control system 126 is a comprehensive power management system incorporating a removable, swappable, or permanently fixed battery or battery packs, enhancing operational flexibility and environmental friendliness. The monitoring and control system 126 may control and monitor battery charging and usage for extended battery life and improved cutter performance. The monitoring and control system 126 may also utilize an economy mode (eco-mode) to conserve energy and extend battery life.

The monitoring and control system 126 may be configured to, upon receiving a signal from the second sensor 138, stop or change a speed of one or both of the electric motors 116A, B to avoid an obstacle or hazard. The monitoring and control system 126 may be configured to enact an automatic safety shutdown in response to receiving the signal from the second sensor 138 or in response to an operational anomaly such as an issue with the battery or the electric motors 116A, B. The monitoring and control system 126 may also generate alerts or signals associated with the above maneuvers and actions to apprise the user of the same or to warn or advise the user that certain maneuvers or actions should be performed.

The control inputs 168 may be used by an operator to control the steering link 152, engagement link 160, electric motors 116A, B and other components. The control inputs 168 may include levers, joysticks, a steering wheel, handlebars, switches, buttons, and the like.

The roofing cart 100 may be modular (in addition to the modularity provided by the coupler 112 and the hitch 114). That is, many of its components such as the electric motors 116A,B and battery 118 may be replaced or swapped with components having different characteristics than the replaced component. This provides adaptability and flexibility for handling different challenges within a roofing project and different roofing projects, and for handling different operator needs. The modularity facilitates customization and upgrades including for the power system components such as the electric motors 116A,B.

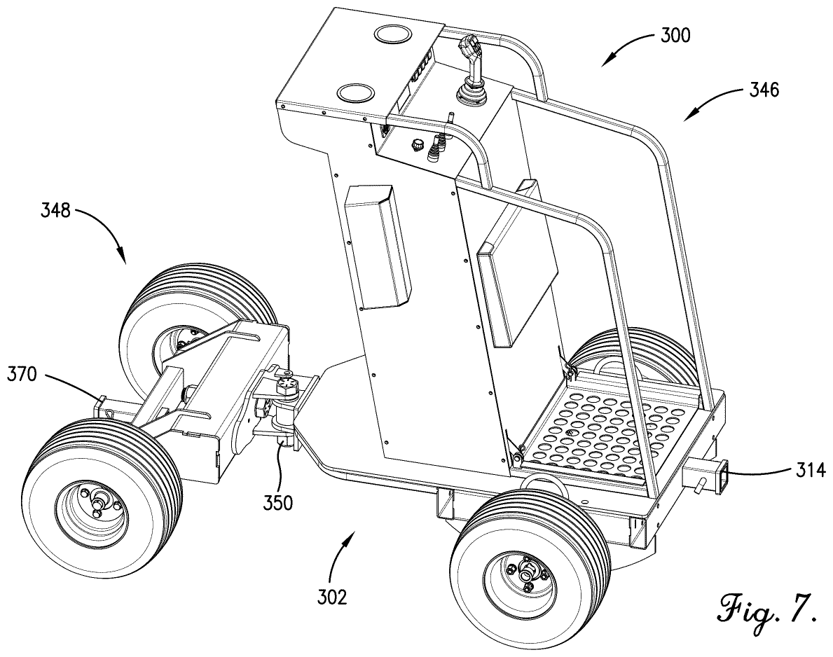

A roofing cart 300 constructed in accordance with another embodiment is shown in FIG. 7. The roofing cart 300 is similar to the roofing cart 100 described above in that the roofing cart 300 includes a chassis 302 having a rear section 346 and a forward section 348. The rear section 346 includes a hitch 314 similar to hitch 114 described above. The forward section 348 includes an additional hitch 370 instead of or in addition to a coupler.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A roofing cart for use on a roof and compatible with a plurality of roofing implements, the roofing cart comprising:
a chassis including a coupler; and
a plurality of wheels rotatably connected to the chassis for traversing the roof,
wherein the coupler is configured to interchangeably connect to the plurality of roofing implements.

2. The roofing cart of claim 1, wherein the plurality of roofing implements include a dump bucket, a forklift, and a roll handler.

3. The roofing cart of claim 1, wherein the roofing cart is configured to tow a plurality of roofing implements, the roofing cart further comprising a hitch configured to interchangeably connect to the plurality of roofing implements.

4. The roofing cart of claim 3, wherein the plurality of roofing implements include a trailer.

5. The roofing cart of claim 3, wherein the coupler and the hitch are on opposite ends of the chassis.

6. The roofing cart of claim 1, further comprising:
an electric motor configured to drive one of the plurality of wheels; and
a battery configured to provide power to the electric motor.

7. The roofing cart of claim 6, wherein the electric motor is a variable speed motor for propelling the roofing cart at a plurality of speeds.

8. The roofing cart of claim 1, further comprising a monitoring and control system configured to:
transmit a wireless signal representing data pertaining to the roofing cart; and
receive a wireless signal representing a command for remotely controlling the roofing cart.

9. The roofing cart of claim 1, wherein the battery is removable for replacing the battery.

10. The roofing cart of claim 1, further comprising a platform for standing thereon and a seat for sitting thereon such that the roofing cart is configured to operate in a walk-behind mode, a stand-on mode, and a sit-on mode.

11. A roofing cart for use on a roof, the roofing cart comprising:
a chassis including a coupler;
a plurality of wheels rotatably connected to the chassis for traversing the roof;
a dump bucket configured to receive roofing material;
a forklift configured to support roofing material; and
a roll handler configured to hold a roll of roofing material,
wherein the coupler is configured to interchangeably connect to the dump bucket, the forklift, and the roll handler.

12. The roofing cart of claim 11, wherein the roofing cart is configured to tow a plurality of roofing implements, the roofing cart further comprising a hitch configured to interchangeably connect to the plurality of roofing implements.

13. The roofing cart of claim 12, wherein the plurality of roofing implements include a trailer.

14. The roofing cart of claim 12, wherein the coupler and the hitch are on opposite ends of the chassis.

15. The roofing cart of claim 11, further comprising:
an electric motor configured to drive one of the plurality of wheels; and
a battery configured to provide power to the electric motor.

16. The roofing cart of claim 15, wherein the electric motor is a variable speed motor for propelling the roofing cart at a plurality of speeds.

17. The roofing cart of claim 11, further comprising a monitoring and control system configured to:
transmit a wireless signal representing data pertaining to the roofing cart; and
receive a wireless signal representing a command for remotely controlling the roofing cart.

18. The roofing cart of claim 11, wherein the battery is removable for replacing the battery.

19. The roofing cart of claim 11, further comprising a platform for standing thereon and a seat for sitting thereon such that the roofing cart is configured to operate in a walk-behind mode, a stand-on mode, and a sit-on mode.

20. A roofing cart for use on a roof, the roofing cart comprising:
a chassis including a coupler and a hitch, the coupler and the hitch being on opposite ends of the chassis;
a plurality of wheels rotatably connected to the chassis for traversing the roof;
a variable speed electric motor configured to drive one of the plurality of wheels for propelling the roofing cart at a plurality of speeds;
a replaceable battery configured to provide power to the electric motor;
a dump bucket configured to receive roofing material;
a forklift configured to support roofing material;
a roll handler configured to hold a roll of roofing material;
a platform supported on the chassis for standing thereon;
a seat supported on the chassis for sitting thereon such that the roofing cart is configured to operate in a walk-behind mode, a stand-on mode, and a sit-on mode; and
a monitoring and control system configured to:
transmit a wireless signal representing data pertaining to the roofing cart; and
receive a wireless signal representing a command for remotely controlling the roofing cart,
wherein the coupler is configured to interchangeably connect to the dump bucket, the forklift, and the roll handler, and
wherein the hitch is configured to interchangeably connect to a plurality of roofing implements.
